(19) United States
(12) Patent Application Publication
(10) Pub. No.: US 2018/0205303 A1
(43) Pub. Date: Jul. 19, 2018

(54) Magnet Motor

(71) Applicant: Marco DEL CURTO, Maienfeld (CH)

(72) Inventor: Marco DEL CURTO, Maienfeld (CH)

(21) Appl. No.: 15/743,320

(22) PCT Filed: Jul. 13, 2016
(86) PCT No.: PCT/CH2016/000104

§ 371 Date: Jan. 10, 2018

(30) Foreign Application Priority Data
Jul. 14, 2015 (CH) 1033/15

(51) Int. Cl. H02K 35/02

(52) U.S. Cl. CPC H02K 35/02

(57) ABSTRACT

The inventive magnet motor comprises at least two magnets (1, 2), as well as at least one armature (3) that can be displaced along a linear axis (Y-Y) and is preferably associated with a stationary stator (4, 5). The armature (3) and the stator (4, 5) may be realized in the form of a linear generator. At least one first magnet (2, 6) is arranged on the armature (3). At least one polarity-reversible second magnet (1, 7) is arranged along said axis (Y-Y) in such a way that it is not dependent on the motion of the linearly displaceable armature (3). The polarity reversal of the second magnet (1, 7) is realized due to its rotation about a second axis (X-X) extending coaxial to the first axis (Y-Y). Depending on its polarization (S, N), the first magnet (2, 6) is respectively attracted (11) or repelled (12) by the face side of the armature (3) such that the armature (3) can be displaced along said axis (Y-Y) due to the magnetic force. The rotation of the first magnet about its axis (X-X) may take place in a cyclic fashion. In this way, the at least one armature (3) can carry out a repetitive reciprocating motion (16), for example by additionally utilizing the force of a driving device with springs (8, 9).

The present invention relates to a magnet motor with at least two magnets, as well as at least one armature that can be displaced along at least one linear axis and at least one stationary stator.

Various magnet motors, particularly permanent magnet motors, in which magnetic energy should be converted into kinetic energy, have already been proposed. In this case, the magnetic forces of repulsive or attractive magnet poles should be converted into a motive force, for example into a rotational force for generating electric energy. It remains unknown whether such a permanent magnet motor has ever worked as intended. However, any electric motor for rotational or for linear motions is actually based on the forces that different magnetic fields exert upon one another. Consequently, any electric motor could be regarded as a magnet motor although electric energy rather than magnetic energy is primarily converted into mechanical energy in this case. Either way, it is undisputed that the attractive or repulsive effects of magnets can be technically utilized.

Based on these circumstances, the invention aims to develop a magnet motor that utilizes magnetic fields.

The inventive magnet motor corresponds to the characterizing features of claim 1. Other advantageous embodiments of the inventive idea can be gathered from the dependent claims.

Preferred exemplary embodiments of the invention are described in greater detail below with reference to the figures.

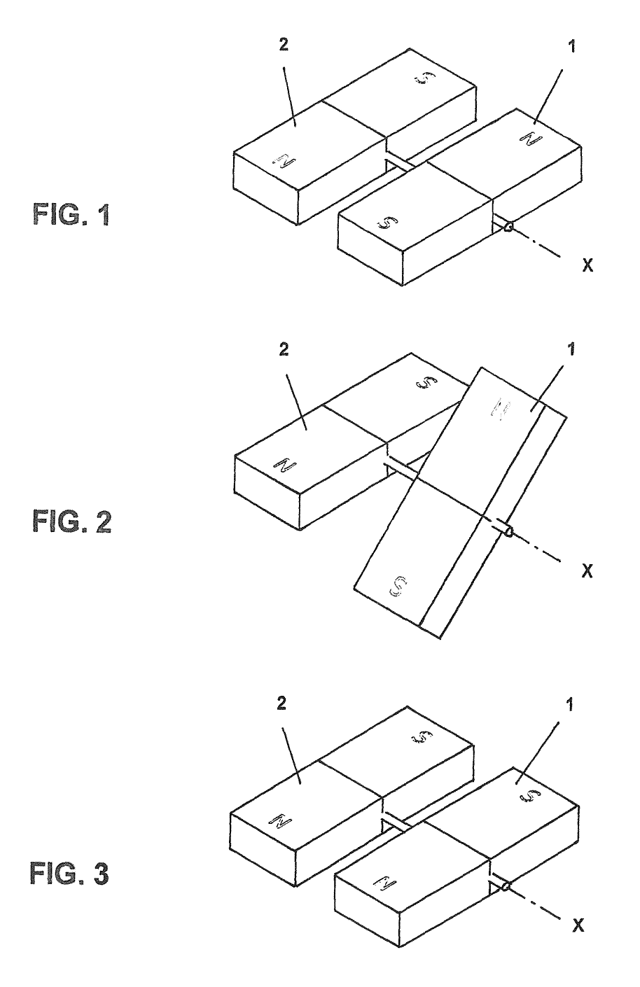

FIGS. 1-3 show magnet pairings in three different positions in order to elucidate the basic principle;

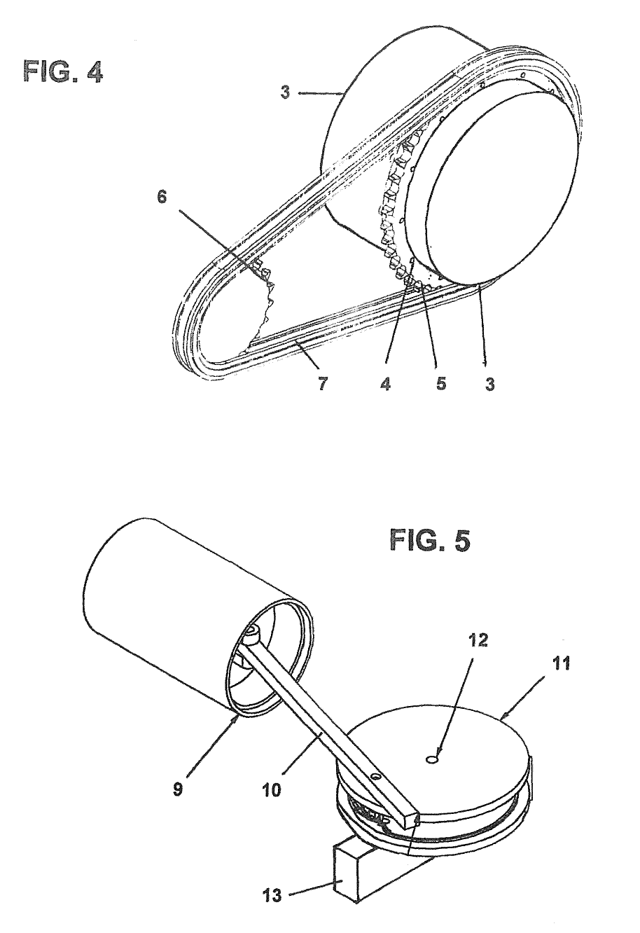

FIG. 4 shows a schematic view of the movable components of a first exemplary embodiment of the inventive magnet motor;

FIG. 5 likewise shows a schematic view of a first magnet motor with linear motion axis;

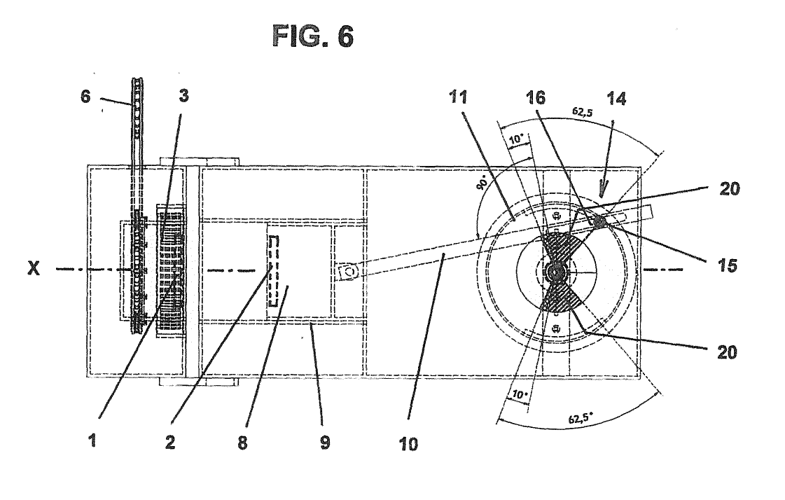

FIG. 6 likewise shows a schematic view of a second magnet motor with linear motion axis;

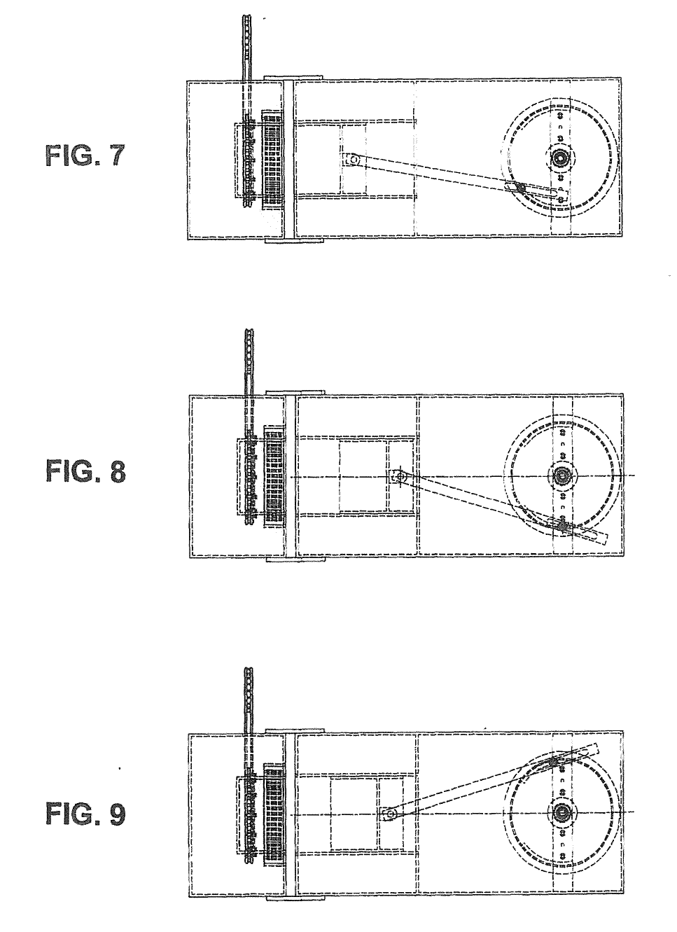

FIGS. 7-8 show a functional example in the form of the magnet motor according to FIG. 5 in different positions;

FIG. 9 shows a section along the line A-A in FIG. 8;

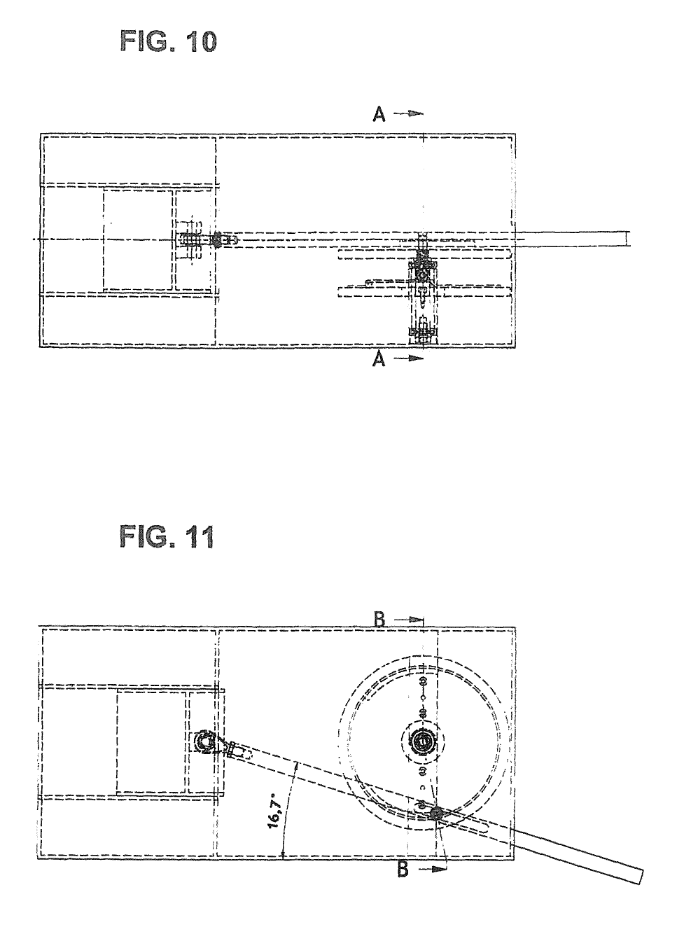

FIG. 10 shows an example of an armature locking mechanism; and

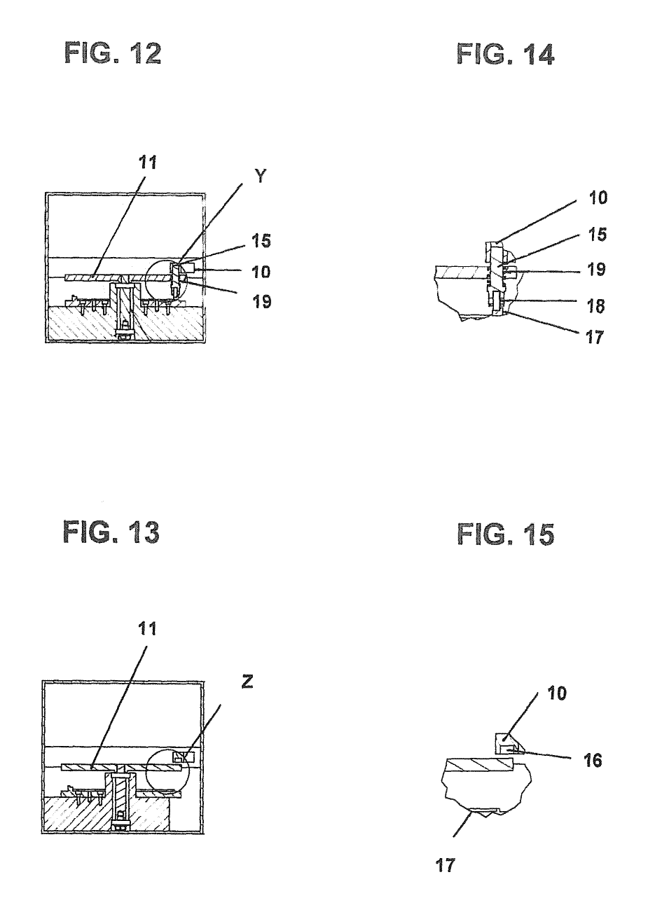

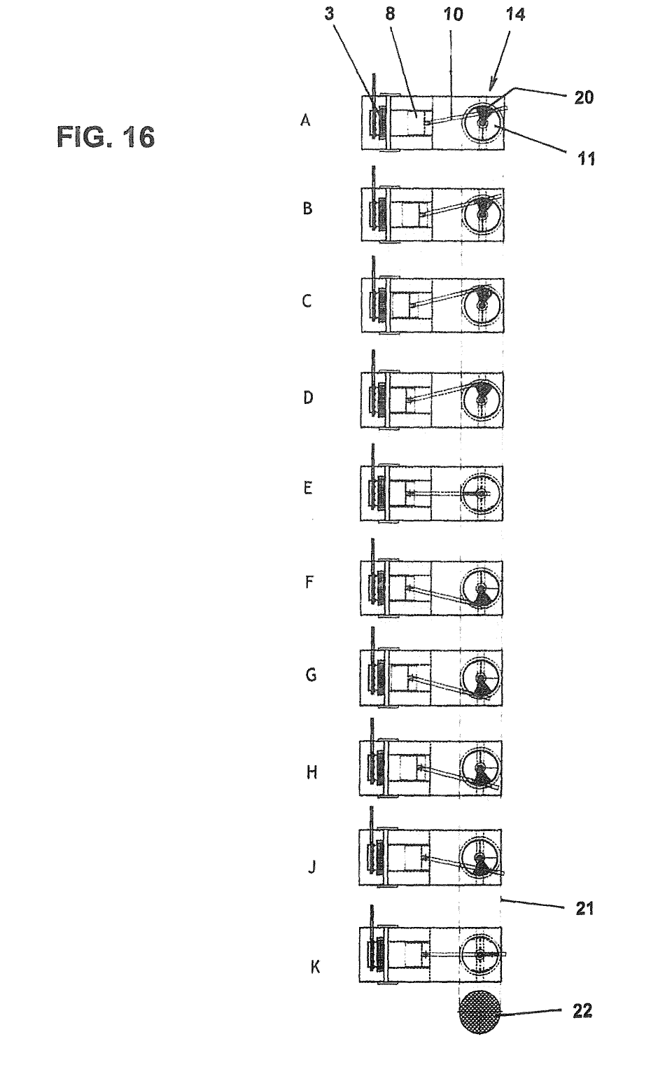

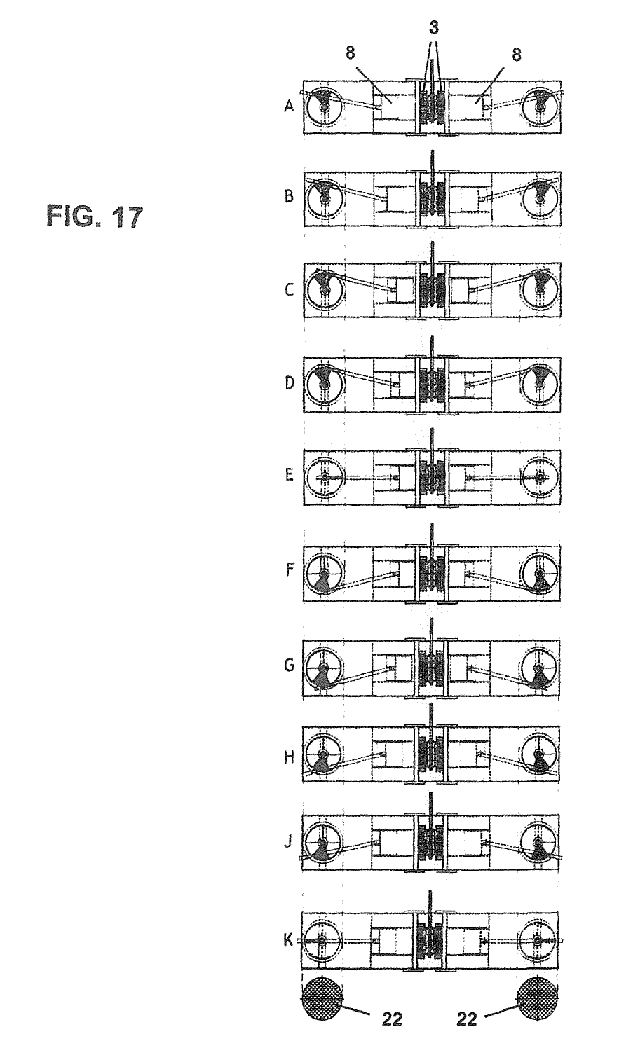

FIG. 11 shows an exemplary embodiment with a curved motion axis.

The magnet motor respectively comprises at least one magnet pairing with at least two magnets 1 and 2 or at least one driving element with such a magnet pairing. Their preferred arrangement is illustrated as an example in FIGS. 1-3, wherein the magnets 1 and 2 lie adjacent to one another in parallel and at least one of the two magnets 1 is rotatable about an axis X-X. In this case, the magnets 1 and 2 are aligned parallel to one another in such a way that both magnetic poles S and N of both magnets 1 and 2 respectively act upon one another. Due to the aforementioned rotation according to FIG. 2, the position of the two magnets 1 and 2 relative to one another can be changed such that either the magnetic poles S/N and N/S face one another as illustrated in FIG. 1 or the magnetic poles S/S and N/N face one another as illustrated in FIG. 3. A magnetically attractive effect is generated between the two magnets 1 and 2 in the first position according to FIG. 1. In contrast, the two magnets 1 and 2 repel one another in the second position according to FIG. 3. Consequently, an attraction or repulsion can be alternately generated due to the rotation, which may take place, for example, in a cyclic fashion and is realized by means of a drive in the form of an electric motor.

In the simplified schematic representations of the basic principle illustrated in FIGS. 1-3, this attraction or repulsion takes place along the longitudinal direction of the described and illustrated axis X-X, which forms the rotational axis. The rotational axis and the linear motion axis of at least one of the two magnets 1 or 2 are identical. In contrast, a different arrangement of the magnets is provided in the following exemplary embodiments, wherein the described repulsion and attraction effects, i.e. the respective linear motion, takes place along a second axis Y-Y extending perpendicular to the first axis X-X in this case. Accordingly, the invention can be implemented in different ways. The magnet motor described below is based on the aforementioned principle that generates a repetitive reciprocating motion. The linearly accumulating kinetic energy can be converted into electrical energy in the form of a linear generator.

The magnet motor according to FIGS. 4 and 5 is designed in the form of a linear motor with at least one movable component, namely the armature 3, and at least one stationary component, namely the stator 4 and/or 5. At least one magnet pairing 1 and 2 is provided for driving the armature 3. In the exemplary embodiment shown, two magnet pairings are provided, namely the magnets 1 and 2 on the one hand and the magnets 6 and 7 on the other hand. With respect to the at least one stator 4 and/or 5, it should be noted that respective stators 4 and 5 may also be provided on the top and the bottom. However, it would also be conceivable to provide a single stator in the form of a profile that at least partially encloses the armature 3. For example, the stator 4 or 5 could accordingly consist of a tube, in which the armature 3 in the form of a cylinder is movably arranged.

The movable components of this first exemplary embodiment of the inventive magnet motor are initially described below with reference to FIG. 4. The armature 3 is located in the center and realized in the form of a component that can be moved along the axis Y-Y. At least one magnet 2 is arranged on the armature 3. In this example, two magnets 2 and 6 are provided on the armature. These magnets are respectively associated with at least one polarity-reversible magnet, in this case a rotatable magnet 1 or 7, in the direction of the aforementioned axis Y-Y. The latter magnets 1 and 7 are not fixed on the armature 3 and therefore not dependent on its mechanical motions. The rotatable magnets 1 and 7 are respectively rotatable about a separate axis X-X extending perpendicular to the first axis Y-Y. A different magnetic pole S or N of the respective rotatable magnet 1 or 7 is therefore aligned with the corresponding magnet 2 or 6 of the armature 3 depending on the rotational position. In this way, the aforementioned attraction or repulsion is generated in dependence on the rotational position.

In the present exemplary embodiment, the armature 3 can be held in an imaginary idle position along its motion axis Y-Y, which approximately lies in the center between the two rotatable magnets 1 and 7, by means of at least one driving device. Dampers such as hydraulic cylinders or gas cylinders or even simple spring elements may be considered as driving devices. In the simplified example according to FIG. 4, the driving device comprises at least two springs 8 and 9. More specifically, two springs 8 are respectively provided on one face side of the armature 3 and two springs 9 are respectively provided on the other face side. The other end of these springs 8 and 9 is respectively attached to a not-shown fixed point. It goes without saying that the springs 8 and 9 have to be spaced apart from the magnets 1, 2, 6 and 7. The armature 3 can therefore only be moved in one or the other direction along the axis Y-Y against the force of at least one of the two springs or spring pairings 8 or 9. The driving device, which is realized in the form of springs 8 and 9 in this case, may also be provided on only one face side of the armature 3. It is merely crucial that the armature 3 is respectively pushed or pulled away from at least one of the two polarity-reversible or rotatable magnets 1 and 7 along the linear axis Y-Y.

It was already mentioned above that the stator 4 or 5 could also be realized in the form of a tube, in which the armature 3 in the form of a cylinder is movably arranged, and it would therefore also be conceivable to realize the stator and the armature themselves in the form of a damper such as a hydraulic cylinder or gas cylinder. In this way, the function of the above-described additional driving device could be integrated into the stator-armature combination without requiring any additional components.

In the illustrated rotational position of the first rotatable magnet 1 on the left side, its N-pole faces the S-pole of the magnet 2 on the armature 3. On the opposite or right side, the rotational position of the second rotatable magnet 7 results in an N-N pole constellation with respect to the magnet 6 on the armature. However, they could also be S-S poles. It is irrelevant exactly which poles interact with one another as long as an attraction on one side of the armature 3 and a simultaneous repulsion on the other side of the armature, but at least a neutral magnet position, is realized. In this case, the armature 3 would be moved leftward.

The same magnet position is illustrated in the magnet motor according to FIG. 5, which is respectively designed in the form of a linear motor or linear generator. In this case, the movable component, namely the armature 3, is arranged opposite of at least one stationary component, namely the stator 4 and/or 5. The motion of the armature 3 relative to the stator 4 and/or 5 makes it possible to generate an electric current in the region 10 between these two components with a known technical principle. Magnets may likewise be provided in this case, but the function of these magnets does not correspond to the function of the magnets 1, 2, 6 and 7. This region 10 may optionally form a friction surface.

As mentioned above, an attraction 11 takes place on the left side in this magnet position and a repulsion 12 takes place on the right side such that the armature 3 is moved leftward relative to the stator 4 and/or 5. The maximum leftward motion of the armature is reached once the distance 13 between the armature 3 and the polarity-reversible or rotatable magnet 1 on this side is reduced to zero. The corresponding distance 14 from the second rotatable magnet 7 simultaneously increases on the right side. The maximum freedom of motion 15 of the armature 3 is therefore defined by these two magnets 1 and 7. A repetitive reciprocating motion 16 can be carried out between these magnets. In this embodiment, it is advantageous to provide a stop for the armature 3 at both ends of the reciprocating motion 16 such that sufficient space for the rotation of the magnets 1 and 7 about the axis X-X remains between the face sides of the armature and these magnets.

In the similar embodiment according to FIG. 6, the magnet arrangement corresponds to FIGS. 1-3. In this case, the rotational axis of the magnets 1 and 7 corresponds to the linear motion axis of the armature 3. This means that the axis X-X lies in the extension of and extends coaxial to the axis Y-Y. However, the axis X-X could also be slightly offset, i.e. it could extend parallel to the linear axis Y-Y. In any case, the magnet pairings 1, 2 on the one hand and 6, 7 on the other hand extend parallel to one another. In the illustrated magnet position, an attraction 11 is generated on the left side and a repulsion 12 is generated on the right side.

The functional sequence is illustrated in FIGS. 7 and 8, both of which are based on the embodiment according to FIG. 5. FIG. 7 shows the first or left end position of the reciprocating motion 16 of the armature 3. In this case, the merely indicated springs 8 and 9 are either compressed or extended. A rotation or polarity reversal of the magnets 1 and 7 takes place after the end position according to FIG. 7 has been reached. FIG. 8 shows the second rotational position or polarity of said magnets 1 and 7. In contrast to FIG. 7, a homopolar pole constellation S-S, which generates a repulsion 12, is then adjusted on the left side whereas the N-pole of the magnet 6 of the armature 3 and the S-pole of the second rotatable magnet 7 face one another on the right side. The thusly generated attraction forces the armature 3 into the second or right end position of the reciprocating motion 16. The next reciprocating motion 16 is initiated with another polarity reversal and once again takes place in the opposite direction such that it can be endlessly repeated. This would also apply analogously to the embodiment according to FIG. 6.

FIG. 9 schematically shows an example of a low-friction guidance of the armature 3 in the form of a section along the line A-A in FIG. 8. This armature is supported on rollers 17 and 18. The latter may rotate about an axle that is arranged on the armature 3 and run along a corresponding track 19. Alternatively, the rollers 17 and 18 may rotate about an external axle, in which case the corresponding track is arranged on the armature 3, for example in the form of a flange 20. It would naturally also be conceivable to provide more than the two exemplary rollers 17 and 18 shown. In this context, it is advantageous to provide at least four rollers 17 and 18 in order to adequately support the armature 3. However, a corresponding support on ball bearings could also be realized.

With respect to the armature 3, it would furthermore be possible to detain this armature in the respective end positions of its reciprocating motion 16, which are illustrated in FIGS. 7 and 8. The armature can be detained at least until the magnets 1 and 7 have been rotated or their polarity has been revised and the motion in the opposite direction can be initiated. An armature locking mechanism 21 suitable for this purpose is illustrated in a purely schematic fashion in FIG. 10. Multiple armature locking mechanisms 21 may also be provided. In this example, the armature locking mechanism 21 comprises a latch or bolt that can engage into a recess or depression in order to thereby prevent the armature 3 for moving. The armature 3 is unlocked again once this armature locking mechanism 21 is mechanically or magnetically released from the engaged position shown. However, if the driving device comprises, for example, dampers in the form of hydraulic cylinders or gas cylinders rather than springs 8 and 9, these dampers may be provided with a brake that fulfills the function of the armature locking mechanism and temporarily detains the armature 3. The released armature 3 then immediately shoots in the direction of the opposite end position with the full available force. In other words, the driving device comprising, for example, springs 8 and 9 boosts the driving power, which is supplemented by the armature locking mechanism 21, in order to thereby enhance the efficiency.

In contrast to the previously described example of a magnet motor with linear motion axis, FIG. 11 shows a magnet motor with a curved motion axis. In other words, the axis Y-Y defining the path of the armature 3 forms an arc. This generates a centering force in the direction of the imaginary idle position shown, which corresponds to the idle position according to FIG. 5. Consequently, the gravitational force alone already acts in the moving direction from both end positions. In other respects, this embodiment may correspond to the embodiments described so far, namely also in terms of the guidance of the armature 3 in the stator 4 and/or 5. However, a driving device in the form of springs or the like may still be provided. The armature 3 could theoretically also be suspended on a pendulum 22 that can be pivoted about an axis 23 as indicated with broken lines. In this case, any springs 8 and 9 could be attached to the pendulum 22.

In each embodiment of the magnet motor, multiple components shown, particularly multiple armatures 3, stators 4 and/or 5 and rotatable or polarity-reversible magnets 1 and 7, can be arranged in series. In this way, multiple magnet motors would ultimately be arranged adjacently and coupled to one another. It would be preferred to realize a series arrangement along an axis that approximately corresponds to the axis X-X in FIG. 4. This provides the option of operating the individual motors or motor segments of the series in different cycles. It would particularly be conceivable to adapt the reciprocating motions 16 of a plurality of armatures 3 to one another in such a way that they are respectively located in different positions during the operation. For example, when the armature 3 of the first magnet motor or magnet motor segment is in the left end position, the armature of the second magnet motor a magnet motor segment is in the right end position. The armature 3 of the third magnet motor segment may be in the central position and other armatures may be in positions in between. All in all, this ensures that no standstill and efficiency loss occurs when an armature 3 reaches an end position and only starts to move again in the opposite direction with a certain delay.

Multiple magnet motors or magnet motor segments may alternatively or additionally also be arranged in series along the axis Y-Y. In the latter instance, the adjoining second magnet motor segment can also utilize a rotatable or polarity-reversible magnet 1 or 7 of the first magnet motor segment. Its rotation or polarity reversal would then simultaneously affect two armatures 3, which ultimately move along the same axis Y-Y. This is also possible in the example according to FIG. 11, in which multiple arc sections would follow one another, if applicable until a closed circle is formed.

The individual components of the magnet motor may within the scope of the invention according to claim 1 naturally also be realized other than described. This particularly also includes an electromagnetic polarity reversal of the respective magnet 1 and/or 7 instead of the magnet rotation. In any case, the armature 3 may consist of one piece or multiple pieces as illustrated in FIGS. 5-9. It would furthermore be conceivable to provide the armature 3 with only one magnet 2 or 6 as long as its poles generate an appropriate magnetic field on the face side in the respective direction of the linear axis Y-Y. With respect to the embodiment according to FIG. 5, it would furthermore be conceivable to provide only one motion-independent magnet 1 or 7 along the linear axis Y-Y, wherein this magnet respectively causes the armature 3 to carry out a repetitive reciprocating motion 16 due to attraction 11 or repulsion 12. In this case, a stop could be provided on this far end of the linear axis Y-Y referred to the magnet 1 or 7.

At least one additional component 24 or 25 may be respectively provided between the at least one magnet 2 and/or 6 arranged on the armature and the section of the armature 3 acting relative to the stator 4 and/or 5 in the region 10. This component 24 and/or 25 may serve for magnetically shielding the magnets 2 and 6 arranged on the armature from the stator 4 and/or 5. The at least one component 24 and/or 25 may alternatively or additionally also fulfill the function of a centrifugal mass.

Another technical characteristic can be gathered from FIG. 11. In this example, at least one spring element 26 is provided on the bottom in the drawing as an alternative to the above-described springs 8 and 9 and connects the armature 3 to a mounting device 27. The latter is arranged at a distance from the armature 3, in this case even outside the stators 4 and 5. Since the armature 3 can be moved between the end positions 28 and 29, the distance between the mounting device 27 and the armature 3 and therefore also the length and the tensile force of the spring element 26 respectively vary. The mounting device 27 of the spring element 26 particularly can be displaced along an axis 30 that approximately extends parallel to the linear motion axis Y-Y of the armature 3. Since the mounting device 27 is respectively moved in the opposite direction of the end position 28 or 29 of the armature 3, the tension acting upon the armature 3 can be intensified in order to promote its motion along the linear axis Y-Y.

In any case, the described examples should merely be regarded as functional layouts and are not binding with respect to sizes and proportions.

1. A magnet motor with at least two magnets (1, 2), as well as at least one armature (3) that can be displaced along at least one linear axis (Y-Y) and at least one stationary stator (4, 5), wherein at least one first magnet (2, 6) is arranged on the at least one armature (3) and at least one polarity-reversible second magnet (1, 7) is arranged along said linear axis (Y-Y) in such a way that it is not dependent on the motion of the linearly displaceable armature (3) and that it respectively attracts (11) or repels (12) the at least one first magnet (2, 6) of the armature (3) depending on its polarization (S, N) in order to thereby displace the armature (3) along said axis (Y-Y) due to the magnetic force, and wherein the polarity reversal (S, N) of the at least one magnet (1, 7), which is arranged such that it is not dependent on the motion of the at least one armature (3), can be realized due to a rotation about an axis (X-X) that is transversal to the linear axis (Y-Y) of the magnet motor, characterized in that the magnets (1, 2, 6, 7) are approximately arranged parallel to one another.

2. (canceled)

3. (canceled)

4. (canceled)

5. (canceled)

6. (canceled)

7. (canceled)

8. The magnet motor according to claim 1, characterized in that a magnet (2, 6), the poles (S, N) of which generate a magnetic field on the face side in the respective direction of the linear axis (Y-Y), is arranged on the at least one armature (3).

9. The magnet motor according to claim 1, characterized in that two magnets (2, 6) are arranged on the at least one armature (3), namely on the respective face sides of the armature (3) along the linear axis (Y-Y).

10. The magnet motor according to claim 1, characterized in that the linear axis (Y-Y) is either straight or curved.

11. The magnet motor according to claim 1, characterized by at least one driving device that drives the at least one armature (3) away from at least one of the two polarity-reversible or rotatable magnets (1, 7) along its linear axis (Y-Y).

12. The magnet motor according to claim 5, characterized in that the at least one armature (3) is held in an imaginary idle position along its linear axis (Y-Y) between the two polarity-reversible or rotatable magnets (1, 7) by the at least one driving device, wherein the at least one armature (3) can be moved against the force of said driving device due to the magnetic force of said magnets (1, 7).

13. The magnet motor according to claim 6, characterized in that the driving device is formed by at least one spring element such as springs (8, 9), which are attached to the at least one armature (3), for example one face side thereof, with one end and to a fixed point that is spaced apart from the armature (3) with the other end.

14. The magnet motor according to claim 6, characterized in that at least one damper such as a hydraulic cylinder or gas cylinder is provided as driving device.

15. The magnet motor according to claim 8, characterized in that the stator (4, 5) and the armature (3) themselves are realized in the form of a damper, wherein the armature (3) in the form of a hydraulic cylinder or gas cylinder is guided in a stator (4, 5) that is realized in the form of a close profile, for example in a tubular fashion.

16. The magnet motor according to claim 1, characterized by at least one disengageable armature locking mechanism (21), by means of which the at least one armature (3) can be detained in a respective end position of its reciprocating motion (16).

17. The magnet motor according to claim 10, characterized in that the at least one armature locking mechanism (21) comprises a latch or bolt, which is designed for engaging into a recess or into a depression.

18. The magnet motor according to claim 10, characterized in that the at least one armature locking mechanism (21) forms part of the driving device of the at least one armature (3), for example a brake.

19. The magnet motor according to claim 2, characterized in that the linear axis (Y-Y) is curved and the at least one armature (3) is suspended on a pendulum (22).

20-23. (canceled)
